(19) United States
(12) Patent Application Publication
(10) Pub. No.: US 2003/0058904 A1
(43) Pub. Date: Mar. 27, 2003

(54) Pulse-generating laser

(75) Inventors: Lukas Krainer, Zurich (CH); Gabriel J. Spuehler, Zurich (CH); Rudiger Paschotta, Zurich (CH); Kurt Weingarten, Zurich (CH); Ursula Keller, Zurich (CH)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: GigaTera AG, Dietikon (CH)

(21) Appl. No.: 09/962,261

(22) Filed: Sep. 24, 2001

(51) Int. Cl. H01S 3/098; H01S 3/10; H01S 3/091; H01S 3/092

(52) U.S. Cl. 372/25; 372/18; 372/70

(57) ABSTRACT

An optically pumped laser with an Er:Yb: doped solid state gain element is disclosed, which is passively mode-locked by means of a semiconductor saturable absorber mirror. The laser is designed to operate at a fundamental repetition rate exceeding 1 GHz and preferably at an effective wavelength between 1525 nm and 1570 nm. Compared to state of the art solid state pulsed lasers, the threshold for Q-switched-mode-locked operation is substantially improved. Thus, according to one embodiment, the laser achieves a repetition rate beyond 40 GHz. The laser preferably comprises means for wavelength tuning and repetition rate locking.

### FIELD OF THE INVENTION

This invention relates to lasers, and more particularly to passively mode-locked solid-state lasers designed to operate at high repetition rates exceeding 1 GHz.

### BACKGROUND OF THE INVENTION

Pulsed lasers are becoming highly important for telecom applications. As data transmission rates continue to increase, the base data transmission rate for high-end systems is moving from 10 GHz (e.g. defined by the SONET/SDH OC-192 standard among others) to approximately 40 GHz (e.g. defined by OC-768 standard among others). These higher data rates become increasing difficult due to affects of chromatic and polarization mode dispersion. State of the art systems use non-return-to-zero (NRZ) modulation format, and this format is more susceptible to degradations due to these affects than a return-to-zero (RZ) format. In addition, an RZ format allows the use of optical pulses, and ultimately the use of related soliton affects, including soliton dispersion management techniques.

Also, as the data rate goes up, for a given average power coming from the optical source, the energy per bit goes down. This decreases the signal-to-noise ratio at the receiver end of the system, if all other parameters are assumed to be constant. Therefore, it is desirable to have increased average power at higher repetition rates to compensate for this and maintain appropriate signal-to-noise levels. The average power achievable is ultimately limited by nonlinear effects in the fiber (stimulated Brillouin scattering (SBS), self-phase modulation (SPM), related phenomena such as four-wave mixing etc.). Further, the achievable average power is also limited by maximum thermal power handling capabilities of the fiber. With a pulsed format, the amount of SPM increases due to the increased intensity at the peak of the pulse. At the same time, the threshold for SBS is increased, i.e. improved due to the increased bandwidth of the signal, which in turn are due to the shorter temporal pulses. Recently, solutions such as soliton-based and dispersion-manage soliton systems have been proposed, which require clean Gaussian or hyperbolic-secant-squared pulse shapes, to further improve transmission at high repetition rates through fiber systems.

This invention relates to the field of pulsed lasers with high repetition frequencies. Passive modelocking of solid-state lasers has been demonstrated to frequencies as high as 77 GHz (see Krainer, et. al., “77 GHz soliton modelocked NdYVO₄ laser”, Electronics Letters, vol. 36, no. 22). Passive modelocking is limited by the onset of Q-switched modelocking (QML) as e.g. described in WO 00/45480 and various scientific publications. According to the sate of the art, Nd:Vanadate is the material of choice for passively mode-locked solid-state lasers due to its excellent crystal quality, strong pump absorption, and high laser cross section which helps avoid the onset of QML.

Modelocking is a special operation regime of lasers where an intracavity modulation (amplitude or phase modulator) forces all of the laser modes to operate at a constant phase, i.e., phase-locked or “mode-locked”, so that the temporal shape of the laser output forms a continuously repeating train of short (typically in the range of picoseconds or femtoseconds) optical pulses. The repetition rate of this pulse train is set by the inverse of the laser round-trip time, or equivalently by the free spectral range of the laser, fᵣₑₚ=c/2 L where c is the speed of light and L is the cavity length for a standing wave cavity. This repetition rate fᵣₑₚ is termed the fundamental repetition rate of the laser cavity, since this corresponds to only one laser pulse circulating in the cavity per round trip. The repetition rate can be scaled by integer multiples N of the fundamental repetition rate under certain conditions, and this is called harmonic modelocking. In this case, there are multiple laser pulses circulating in the cavity per round trip, which can increase the timing and amplitude jitter.

Among the available modelocking techniques, active modelockers have the disadvantages of cost and complexity. A typical device requires a precision electro-optical component, plus drive electronics which typically consists of a high-power, high-stability RF-signal (for acousto-optic modulators) or high-voltage (for electro-optic modulator) components. Additionally, feedback electronics may be required to stabilize either the drive signal for the modulator and/or the laser cavity length to achieve the necessary stability from the system (cf. U.S. Pat. No. 4,025,875, Fletcher et al., “Length controlled stabilized mode-lock Nd:YAG laser” or U.S. Pat. No. 4,314,211, Mollenauer, “Servo-controlled optical length of mode-locked lasers”)

This is one reason why passive modelocking is often the technique of choice for short pulses and high repetition rates. Compared to active modelocking, passive modelocking at the fundamental repetition rate, is a much simpler, robust, and lower-cost approach to generating mode-locked pulses. Passive modelocking relies on a saturable absorber mechanism, which produces either decreasing loss with increasing optical intensity, or similarly an increase gain with increasing optical intensity. When the saturable absorber parameters are correctly adjusted for the laser system, the optical intensity in the laser cavity is enhanced such that a mode-locked pulse train builds up over a time-period corresponding to a given number of round-trips in the laser cavity.

Passive modelocking is also well-established in the state of the art (see A. J. DeMaria et al., “Self mode-locking of lasers with saturable absorbers”, Applied Physics Letters, vol. 8, pp, 174-176, 1966). The most significant developments in passive modelocking in the recent years have been Kerr-Lens Modelocking (KLM) (U.S. Pat. No. 5,163,059, Negus et al., “Mode-locked laser using non-linear self-focusing element”) for generation of femtosecond pulses from Ti:sapphire and other femtosecond laser systems, and the semiconductor saturable absorber mirror (SESAM) device for generating picosecond and femtosecond pulses in a wide number of solid-state lasers (see U. Keller et al., “Semiconductor saturable absorber mirrors (SESAMs) for femtosecond to nanosecond pulse generation in solid-state lasers,” Journal of Selected Topics in Quantum Electronics (JSTQE), vol. 2, no. 3, pp. 435-453, 1996). Absorber structures suited for operation at wavelengths associated with current telecommunication applications, e.g. 1550 nm, have been demonstrated, e.g. in U.S. Pat. No. 5,701,327. Mozdy, et. al., “NaCL:OH— color center laser modelocked by a novel bonded saturable Bragg reflector” Optics Communications 151 (1998) 62-64, Zhang, et. al., “Self-starting mode-locked Cr⁴⁺:YAG laser with a low-loss broadband semiconductor saturable-absorber mirror,” Optics Letters, vol. 24, December 1999, pp. 1768-1770.

Most passively modelocked lasers have been operated at repetition rates of approximately 100 MHz, corresponding to a cavity length of approximately 1.5 m. This cavity length is appropriate for many applications (such as seeding a regenerative laser amplifier) and is also convenient for building laboratory-scale lasers. Previous work has been done to achieve higher repetition rates, which could be important for telecommunications and optical clocking applications (see U.S. Pat. No. 4,930,131, Sizer, “Source of high repetition rate, high power optical pulses”, U.S. Pat. No. 5,274,659, Harvey, et. al., “Harmonically mode-locked laser”, U.S. Pat. No. 5,007,059, Keller et al., “Nonlinear external cavity modelocked laser”; B. E. Bouma et al., “Compact Kerr-lens mode-locked resonators”, Optics Letters, vol. 21, 1996, pp. 134-136; and B. C. Collings et al, “True fundamental solitons in a passively mode-locked short-cavity Cr⁴⁺:YAG laser”, Optics Letters, vol. 22, pp. 1098-2000, 1997).

For passively modelocked lasers using SESAMs for modelocking, the limitation on repetition rate is the onset of Q-switching instabilities (see C. Hönninger et al., “Q-switching stability limits of continuous-wave passive mode locking,” J. Opt. Soc. Am. B, vol. 16, pp. 46-56, 1999.U. Keller et al., “Semiconductor saturable absorber mirrors (SESAMs) for femtosecond to nanosecond pulse generation in solid-state lasers,” Journal of Selected Topics in Quantum Electronics (JSTQE), vol. 2, no. 3, pp. 435-453, 1996, and U. Keller, “Ultrafast all-solid-state laser technology”, Applied Physics. B, vol. 58, pp. 347-363, 1994). This has also limited the laser repetition rate to the range of several hundred megahertz typically. Using the technique of coupled cavity modelocking (RPM), a repetition rate of 1 GHz was demonstrated (see U. Keller, “Diode-pumped, high repetition rate, resonant passive mode-locked Nd:YLF laser”, Proceedings on Advanced Solid-State Lasers, vol. 13, pp. 94-97, 1992). However this is a much more complicated laser due to the additional laser cavity which has to be carefully aligned with the main laser cavity.

Recently, passive modelocking in solid-state lasers has been achieved at fundamental repetition rates beyond 1 GHz. It has been found that if the product (Fₗₐₛₑᵣ/F_{sat,laser})·(F_{abs}/F_{sat,abs})>ΔR, QML operation is prevented. In this relation, Fₗₐₛₑᵣ is the fluence in the laser material, F_{sat,laser}=hυ/(σ_{em,laser}+σ_{abs,laser}) is the saturation fluence of the laser material, h is Planck's constant, υ is the center laser frequency, σ_{em,laser} is the laser emission cross-section section, σ_{abs,laser} is the laser absorption cross-section at the laser wavelength, F_{abs} is the fluence on the absorber device, F_{sat,abs}=hυ/σ_{abs} is the effective saturation fluence of the absorber, where σ_{abs} is the effective cross-section parameter of the absorber device, and ΔR is the modulation depth of the absorber device. As a material, Nd:Vanadate having a relatively high stimulated emission cross section is well-suited for this use.

However, Nd:Vanadate and similar Nd-doped crystals and glasses have fixed laser wavelengths, mostly near 1064 nm, with weaker laser transitions near 1340 nm and 946 nm. For applications in telecommunication systems, it is most desirable to operate at wavelengths in the established (defined by the ITU standard) wavelength range of approximately 1525-1560 nm—the so-called “C-band”, and potentially the adjacent “S-band” (1450-1510 nm) and “L-band” (1570-1620 nm).

One solution to achieve these wavelengths using a passively mode-locked Nd:Vanadate laser at high repetition rates is to use frequency conversion techniques such as an optical parametric oscillator. This is the basis for the patent application PCT/IB00/01040. This approach has the advantage of potential very broad tunability, at the expense of an additional frequency conversion stage, which increases the complexity and cost of the entire system.

It would be more desirable to have a laser system to directly generate wavelengths in the communications wavelength bands. There are several possibilities which are known: Cr⁴⁺:YAG, bulk Er:glass, Er:glass fiber lasers, semiconductor lasers, Er-doped crystals such as Er:Vanadate. Each has certain constraints and trade-offs.

The Cr⁴⁺:YAG, for example, has a large laser cross-section (3.4×10⁻²⁰ cm²) but a very short upper state lifetime, resulting in a laser with very low small-signal gain (approximately 100 times smaller than Er:Yb:glass). This makes designing an efficient and robust laser difficult. In addition, the preferred pump wavelength of 1064 nm requires a large, powerful, Nd:YAG or Nd:Vanadate system with a near-diffraction-limited output beam, due to the low absorption coefficient at the pump wavelength. This is both expensive and not conducive to miniaturization. Finally the crystal quality of Cr:YAG is still an issue, as it is reportedly difficult to get good quality crystals, even in small quantities.

Semiconductor lasers have also been demonstrated to work at very high repetition rates and at telecom wavelengths. Semiconductor lasers however suffer from low average power typically. Also the structures required to achieve passive modelocking can be rather complicated requiring many different process steps in the fabrication.

Fiber lasers have also been demonstrated to work at very high repetition rates and at telecom wavelengths. However these lasers can be very complex and always require some technique to increase the repetition rate above the fundamental cavity repetition rate (i.e. harmonic mode-locking) since the use of fiber and fiber-optic elements require cavity lengths on the order of several or many centimeters. This is due to the fact that the available gain per meter in erbium-doped fiber is small and therefore requires laser lengths of several meters typically. This effectively precludes a mode-locked laser with a fundamental cavity repetition rate of 10 GHz or higher (corresponding to a physical cavity length of approximately 1 cm or shorter) (see Thoen, et. al, “Stabilization of an active harmonically mode-locked fiber laser using two-photon absorption,” Optics Letters, p. 948, year 2000, and see also U.S. Pat. No. 6,108,465 (Ando PGL), U.S. Pat. No. 5,926,492 (NTT PGL), and U.S. Pat. No. 5,590,142 (BT Ring Laser)). In addition, fiber lasers tend to require multiple intracavity components such as beamsplitters, wavelength combiners. polarizers, polarization controllers, waveplates, and saturable absorber elements. This can increase the cost and complexity of these systems substantially. Current commercially available laboratory systems use active modulators which require large RF or microwave drive signals.

Waveguide lasers also have been demonstrated with passive modelocking (J. B. Schlager, et. al., CLEO 2001 Technical Digest, paper CMS1, p.87-88, and Thoen, et. al., “Er:Yb waveguide laser mode-locked with a semiconductor saturable absorber mirror,” IEEE Photonics Technology Letters 12, p. 149 (2000)). Here the motivation is to improve the QML threshold through the confinement of the laser mode in the waveguide, which reduces the saturation fluence in the laser medium, and thus the QML threshold. However, waveguide lasers tend to suffer from low average power due to limits of coupling the pump laser into the waveguide, and the high optical loss typical of waveguide structures. Also it can be difficult to achieve enough gain per unit length so that very short waveguides can be realized.

Diode-pumped bulk Er-doped lasers have been previously demonstrated in continuous-wave operation with good lasing performance (Laporta, et. al, Optics Letters 1993, p. 1232). Bulk Er-doped lasers have been actively modelocked (Laporta, et. al., Photonics Technology Letters, Vol. 7, 1995, p. 155) at gigahertz repletion rates, and also have been passively mode-locked to demonstrate picosecond and sub-picosecond (Spühler et. al., Electronics Letters Vol. 35, no. 7, 1999, pp. 567-569, also G. Wasik, et. al., CLEO 2001 Technical Digest, paper CMA4, pp. 3-4), but at sub-gigahertz repetition rates only. The quality of Er-doped glass is very high, and the cost can be very low (it is similar to the material that is used to make erbium-doped fiber amplifiers (EDFAS) for example).

However all erbium-doped laser materials have a very small stimulated emission cross section (e.g. 8×10⁻²¹ cm² for Er-doped glass) and this would lead one to conclude that due to the above condition, operation at high repetition rates is not possible. This has so far been confirmed by experimental results (see prior references above). Alternate solid-state crystals include for example Er-doped Vanadate (cross section of 5-10×10⁻²¹ cm², see Sokolska, et. al., Applied Physics B (2000) DOI 10.1007/s003400000458) which has laser transitions from 1531 nm to 1604 nm, but to date has been limited to lasing at discrete wavelengths only within this range. However, the cross-section of this type of laser is not substantially better than erbium-doped glasses, although it should have mechanical properties which allow it to be pumped with higher power. Also, lasers with only erbium-doping are typically in efficient due to strong reabsorption losses, which are caused by the typically high erbium-doping required for a reasonable pump absorption. Co-doping with other ions can be used to increase the pump absorption at low erbium doping in order to get good pump absorption and low reabsorption losses. Typically, for erbium-doped glasses, ytterbium (YB) is used as a co-dopant to achieve stronger absorption near 980 nm, where pump diodes are readily commercially available.

Except for the above issue with QML, Er-doped glass lasers appear very attractive for telecom operation. The material quality is very good, it can be manufactured in large volumes and for a low price, it can be pumped by diode lasers near 980 nm, similar to EDFAs which drives a reliable and low-cost pump laser market, and it has a laser transition which covers the C-band approximately, so that it should have tunability from approximately 1525 nm to 1560 nm. In addition, a bulk laser approach has a number of advantages. First it allows us to add additional optical elements for control of the wavelength and cavity length. The features of controllable wavelength (i.e. tunability) and controllable cavity length (i.e. clock synchronization) are key features for current and future optical network systems. Secondly it allows us to use precision micro-optical packaging, which allows us to avoid having to invest in substantial amounts of semiconductor manufacturing equipment.

So the main open technical issue is if it is possible to overcome the QML threshold for a low-cross-section laser material at a wavelength near 1.55 microns. There are two prior-art techniques which have been published. First, it is possible through an inverse saturable effect such as two-photon absorption (TPA) to suppress the saturable absorber at higher intensities, and thus to improve the QML threshold condition with respect to Hönninger (referenced previously) (Schibli, et. al., “Suppression of Q-switched mode locking and break-up into multiple pulses by inverse saturable absorption,” Applied Physics B, S41-S49, (2000)). However TPA is mostly important for sub-picosecond pulses (typically in the sub-200-femtosecond pulse range) where the peak powers become very large compared to the average power. The TPA at the peak of the pulses becomes less of a factor for picosecond pulses. To achieve significant TPA with sub-picosecond pulses, a SESAM design with a special half-wave layer of InP (which has a large TPA coefficient) was specially designed. Schibli specifically discloses that for a picosecond laser, a TPA layer of 1 micron (i.e. up to about 0.65 wavelengths thick) would only decrease the QML threshold by a factor of four.

Secondly, it is possible to provide electronic feedback derived from the monitoring the laser amplitude and then controlling the pump intensity as a technique to suppress relaxation oscillations and effectively the QML behavior of the laser (Schibli, et. al., “Control of Q-switched mode locking by active feedback,” Optics Letters, Vol. 26, February 2001, pp. 148-150, and Joly, et. al., “Suppression of Q-switched instabilities by feedback control in passively mode-locked lasers,” Optics Letters, vol. 26, May 2001, pp. 692-694, and WO 0147075A1). This pump feedback approach, essentially identical to other standard feedback systems to reduce noise in diode-pumped lasers (commonly referred to as “noise eaters”) approaches, provided also the benefit of reduced amplitude noise on the output of the laser, which can also be desirable for certain applications. The disadvantage of this approach is the increased cost and complexity of such a system.

There are other effects which need to be taken into consideration for passive modelocking, and some of these effects become more critical as the repetition rate of the laser increases. It is well known that any optical feedback into the laser can cause instabilities to the mode locking performance of a passively mode-locked laser. The saturable absorber, which starts and stabilizes mode locking, also reacts to fluctuations in the laser power, which originate from optical feedback. If some parasitic pulse with a pulse energy well below the saturation energy of the saturable absorber (originating from some external reflection fed back into the cavity) is hitting the SESAM within the SESAM recovery time (essentially during the time, when the SESAM is bleached), it virtually does not get attenuated by the SESAM. Additionally, unlike the main pulse, the leading edge of this parasitic pulse does not get absorbed by the SESAM, because it does not need to saturate the SESAM. In this way the parasitic pulse experiences a positive net gain per round trip. In this way it can also grow and compete with the main pulse.

This picture explains why passively mode-locked lasers get more sensitive to optical feedback with increasing repetition rate: The integrated time in which the SESAM is bleached, and thus the probability for an optical feedback to hit the SESAM in its saturated state, increases linearly with repetition rate. Analogously, increasing the SESAM recovery time increases the sensitivity towards optical feedback. On the other hand, decreasing the modulation depth of the SESAM decreases the discrimination for pulse energies below the saturation energy of the SESAM. In other words, with a lower modulation depth, a fed-back pulse gets less attenuated compared to the main pulse, as the reflectivity change for the different fluences is smaller (this discrimination effect is directly connected to the mode locking driving force, which increases with increased modulation depth).

Recapitulating, we can state that the sensitivity of a passively mode-locked laser to optical feedback increases with increasing pulse repetition rate, with increasing SESAM recovery time, and with decreasing modulation depth of the SESAM.

Concretely, we occasionally observed modulated optical spectra and/or multiple pulsing for lasers with repetition rates of about 10 GHz and SESAMs with modulation depths in the range of 0.1 to 0.2%. To avoid such effects in these lasers it is very important to avoid any optical feedback. Possible sources for optical feedback are: back reflections from elements in the output beam, back reflections from leakages through mirrors, back reflections from rear faces of used optics (dielectric mirrors, SESAM), back reflections of Brewster reflections from intracavity Brewster elements (mainly the gain). These back reflections can be avoided by corresponding means to which extreme care should be taken: The output beam should pass an optical isolator first, rear faces of all cavity mirrors should be AR coated and the substrates should be wedged, and the Brewster reflections should be blocked without back reflections.

### SUMMARY OF THE INVENTION

It is thus an object of the invention to provide a passively mode-locked solid-state laser suited for operation near and around the key telecom wavelengths centered at 1550 nm and possibly other infrared or visible light frequencies for repetition rates above 1 GHz, preferably exceeding 10 GHz but ultimately exceeding 40 GHz without having to use harmonic modelocking, i.e. operating at the fundamental cavity repetition rate.

According to a first aspect of the invention, a laser for emitting a continuous-wave train of electromagnetic-radiation pulses characterized by an effective wavelength is provided, the fundamental repetition rate of the emitted pulses exceeding 1 GHz, the laser comprising:

an optical resonator;

an Er:Yb:doped solid-state gain element placed inside said optical resonator;

means for exciting said laser gain element to emit electromagnetic radiation characterized by the effective wavelength; and

means for passive modelocking comprising a saturable absorber.

According to a second aspect of the invention, a laser for emitting a continuous-wave train of electromagnetic-radiation pulses characterized by an effective wavelength is provided, the fundamental repetition rate of the emitted pulses exceeding 1 GHz, said laser comprising:

an optical resonator;

a solid state gain element placed inside said optical resonator;

means for exciting said laser gain element to emit electromagnetic radiation characterized by the effective wavelength, said means comprising a single mode diode pump laser; and

means for passive modelocking comprising a saturable absorber.

According to a further aspect of the invention, a laser for emitting a continuous-wave train of electromagnetic-radiation pulses characterized by an effective wavelength is provided, the fundamental repetition rate of the emitted pulses exceeding 1 GHz, said laser comprising:

an optical resonator;

a solid state gain element placed inside said optical resonator;

means for exciting said laser gain element to emit electromagnetic radiation characterized by the effective wavelength, and

means for passive modelocking comprising a low-finesse Semiconductor Saturable Absorber Mirror (SESAM) with GaAs/AlAs mirrors and a less than or equal to 10 nm thick absorber layer comprising InₓGa₁₋ₓAs with 0.5<x<0.56.

According to yet another aspect of the invention, a laser for emitting a continuous-wave train of electromagnetic-radiation pulses characterized by an effective wavelength is provided, the fundamental repetition rate of the emitted pulses exceeding 1 GHz, said laser comprising:

an optical resonator;

an Er:Yb: doped solid-state gain element placed inside said optical resonator;

means for exciting said laser gain element to emit electromagnetic radiation characterized by the effective wavelength; and

means for passive modelocking comprising a saturable absorber,

wherein the optical resonator is designed such that the circulating radiation is focused in a manner that the spatial mode radius on both, the gain element and the absorber is below 50 μm.

The invention also comprises a method for emitting a continuous-wave train of electromagnetic-radiation pulses characterized by an effective wavelength, the pulses being emitted with a fundamental repetition rate exceeding 1 GHz, comprising the steps of:

exciting an Er:Yb: doped solid laser gain element to emit electromagnetic radiation characterized by the effective wavelength,

said laser gain element being placed inside an optical resonator;

recirculating said electromagnetic radiation in said optical resonator; and

passively modelocking said electromagnetic radiation using a saturable absorber.

According to a still further aspect of the invention method for emitting a continuous-wave train of electromagnetic-radiation pulses characterized by an effective wavelength is provided, the pulses being emitted with a fundamental repetition rate exceeding 1 GHz, comprising the steps of:

Focusing an optical pumping beam on a solid state laser gain element for exciting it to emit electromagnetic radiation characterized by the effective wavelength,

said laser gain element being placed inside an optical resonator;

recirculating said electromagnetic radiation in said optical resonator,

passively modelocking said electromagnetic radiation using a saturable absorber, and focusing said electromagnetic radiation such that the spatial mode radius on the gain element is below 80 μm, preferably below 50 μm and on the absorber is below 50 μm.

In summary, features distinguishing different aspects of the invention from the prior art comprise:

An Er:Yb:doped solid-state laser gain element, e.g. a Er:Yb:glass, an Er:Yb:YAG or an Er:Yb:Vanadate laser gain element or any other bulk laser gain element which is doped with Er and Yb. In the following description, it is assumed that the laser gain element is a Er:Yb:glass gain element. The co-doping of the Yb has been observed to have a positive effect on an efficient pump absorption, which allows for very tight mode-matching, which in turn allows to improve the S parameter in the laser crystal. (The co-doping of the Yb has been observed to have a positive effect on an efficient pump absorption, as it allows for an efficient laser with a short gain element and thus for a very small laser mode in the gain still efficiently mode-matched to the pump radiation, which in turn allows to improve the S parameter in the laser crystal.)

High-brightness pump laser, at least 0.1 W, preferably at least 0.2 W or 0.3 W, and even more preferred approximately 500 mW or more from a single-mode diode laser at approximately 980 nm wavelength, but it can also be a 50 micron stripe laser with approximately 1 W output power or similar high-brightness pump laser. The pump laser can also be either free-space coupled or possibly fiber-coupled

Cavity designs optimized for low-optical loss and specially to avoid spurious reflections which could give rise to unwanted etalon effects and optical feedback which subsequently disturb the mode-locked operation. Mirror elements should be highly reflective >99.9%, preferably 99.95%, and output coupler is in the range of 0.2% to 1% typically.

Cavity designs which, despite the—due to the high fundamental repetition rate—limited size allow focusing of the pump beam and of the beam circulating in the resonator. In fact, the mode radius on the absorber and on the gain element is below 50 μm, preferably below 20 μm on the absorber and below 30 μm in the gain material.

“Low-finesse” SESAM with GaAs/AlAs mirrors and a thin absorber using approximately InₓGa₁₋ₓAs with x=53±3%, preferably 53%±1%. No structures to enhance TPA are used, and we expect negligible TPA effects.

we have solved the “problem” of highly lattice mismatched, relaxed absorber layers by using thin layers grown at low-temperatures between 250 and 500° C. and as near the surface of the SESAM structure (i.e. minimizing the amount of material grown on top of the absorber) as possible. ‘Near the surface of the SESAM structure’ in this context means essentially within 200 nm from the surface, preferably within 125 nm from the surface and probably even within 110 nm from the surface.

SESAM designed to have modulation depths below 0.5% (to as low as below 0.1%) and non-saturating loss of <0.5% (similar or better than standard dielectric mirrors.)

The invention makes possible a solid state laser, passively modelocked at or around an effective wavelength of 1550 nm with a SESAM, with an enhanced QML factor (definition in next paragraph) which makes possible very high repetition rates (potentially exceeding 40 GHz) in a fundamental cavity arrangement.

The invention is based on a variety of surprising insights: A first surprising effect is the discovery that a bulk Er:Yb: doped solid laser can be designed to achieve passive CW modelocking with a pulse energy which is substantially lower than that predicted by the accepted QML condition. This is by combining some or all of the above features in one laser. In the following, the decrease in pulse energy compared to the predicted pulse energy is called the “QML factor” q. We observe that the QML factor is improved by a factor of between 5 to 30 for the preferred embodiments, compared to the standard expected QML threshold. In other words, it is observed that instead of (Fₗₐₛₑᵣ/F_{sat,laser})·(F_{abs}/F_{sat,abs})>ΔR, the relation q²(Fₗₐₛₑᵣ/F_{sat,laser})·(F_{abs}/F_{sat,abs})>ΔR holds. This is using a “standard” SESAM designed for an absorption wavelength of 1.55 micron, without any special layers included for extra TPA. Thanks to this effect, higher repetition rates are possible without coming into a Q-switched-mode-locked regime.

A second surprising insight is that a laser cavity with a GHz fundamental repetition rate can be designed in a manner that focusing to very small mode radii on both, the gain material and an absorber element is possible. To this end, as outlined below, mirrors with curve radii well below what has previously been expected are used. Nevertheless, the losses are small or tolerable.

A third surprising insight is that despite a huge lattice mismatch (several %) ‘standard’ InGaAs absorber layers can, in a SESAM device, be used together with a ‘standard’ GaAs/AlAs Bragg mirror element for operation around 1550 nm. Since the In concentration in an absorber layer is given by the wavelength and must be very high, the lattice mismatch in state of the art SESAMs made a use of InGaAs absorbers impossible due to bad quality growth due to relaxation. According to an aspect of the invention, very thin absorber layers grown at very low temperatures are used. For InGaAs absorbers and GaAs spacers, the two-photon-absorption (TPA) is expected to be low. Thus the enhanced QML factor of the laser according to the invention is based on principles so far not known. In fact we expect very weak or even negligible TPA in this structure due to the use of GaAs space layers. GaAs has a bandgap of 830 nm, so that the TPA coefficient for 1550 nm photons is substantially lower than InP for example (26 cm/GW versus 90 cm/GW respectively).

A fourth surprising insight is that a single mode semiconductor pumping laser can be combined with a solid state gain element in a high repetition rate laser, and, together with other features of the invention produce a solid state laser with a repetition rate so far not known.

Further optional features of a laser according to the invention are:

SESAM structure with a back-side wedged and/or roughened to avoid spurious reflections from the back surface which create a disturbing etalon effect

Optionally tuning elements: one or a combination of the following:

Solid etalon in the range of 25 microns to 100 microns thickness

Air-spaced etalon with air gap in the 25 to 100 micron range

Micro-electro-mechanical System (MEMS)-based etalon structure

birefringent filter

tuning the angle of the gain element in the case when it is a Brewster-Brewster plate

changing the position of the SESAM or another mirror element in the cavity to change the laser mode, effectively changing the saturated gain of the laser causing a tuning of the wavelength.

NOTE: it is advantageous to take care with low-modulation depth SESAMs (in the range of 0.1% to 0.2%) to avoid any spurious etalon surfaces in or around the laser cavity. In addition it is beneficial to provide good isolation of feedback into the laser cavity. This is well-known for mode-locked lasers, but it is more critical with high-rep rate lasers with low-modulation-depth SESAMs, as the mode locking driving force decreases with the modulation depth and the integrated time, where the SESAM is saturated increases with repetition rate.

According to an embodiment, a micro-optics arrangement is chosen, which allows the combination of this laser with means to tune and lock the laser wavelength, at the same time to tune and lock the cavity length of the laser to synchronize the pulse repetition rate to a master reference clock.

### BRIEF DESCRIPTION OF THE DRAWINGS

FIGS. 1-4 show embodiments of a laser according to the invention.

FIG. 5 shows the beam radius as a function of the position in a laser according to FIG. 4.

FIG. 6 depicts graphs of the autocorrelation, the optical spectrum, and the microwave spectrum of a 2 GHz laser according to the invention.

FIG. 7 shows a microwave spectrum of a 10 GHz laser according to the invention.

FIG. 8 depicts a SESAM layer structure.

FIG. 9 shows the calculated electric field intensity and the refractive index as a function of the distance from the surface of one preferred SESAM embodiment. Left hand side axis is the refractive index and right hand side the field intensity normalized to 4.

FIG. 10 depicts an embodiment of the laser according to the invention wavelength and cavity length tuning means.

FIG. 11 shows a plot of the measured QML factor as a function of the saturation parameter of the SESAM for a number of different cavity configurations.

### DESCRIPTION OF THE PREFERRED EMBODIMENTS

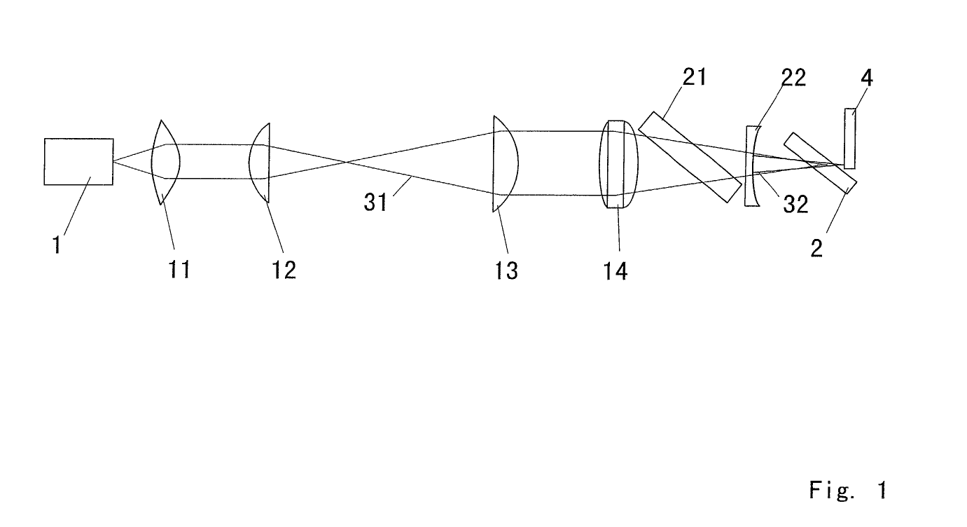

In one preferred embodiment, the invention uses a SESAM device with less than 1% and even more preferably less than 0.5% modulation depth and an Er:Yb:glass gain element. Referring to FIG. 1, a high-brightness, single-mode diode laser 1 (Nortel Model G06d), which emits 980 nm laser light 31 of up to 0.5 W from an aperture size of approximately 1.8 μm by 4.8 μm, is collimated by a short focal length high numerical aperture aspheric pickup lens 11 (focal length 4.5 mm). The beam is then expanded in tangential direction with help of a ×2 (times-two) telescope made of cylindrical lenses 12,13. This telescope turns the elliptic pump beam into an approximately round one and it allows for astigmatism compensation. An achromatic lens 14 is used to focus the pump beam 31 through one cavity mirror 22 down to a radii between 20 and 80 μm in the free space. Between the focusing lens 14 and the cavity mirror 22, we placed a dichroic beam splitter 21 (highly reflective for wavelengths around 1550 nm and highly transmissive around 980 nm under 45° incidence) in order to deflect any laser light directed to the pump laser 1. At the focus of the pump light 31, approximately 0.45 W of pump power was measured at a pump wavelength of nominally 980 nm, which is then available for optically pumping a laser gain element 2. Although single-mode pump diodes are preferable, other formats pump diodes may also be used with properly designed pump optics. For example a 1 W output power from a 1×50 micron aperture broad area diode laser (slightly reduced brightness, but still a so called high-brightness pump laser) emitting at substantially 980 nm (Boston Laser Model 1000-980-50) can also be used to achieve good lasing performance. The advantage of the higher brightness, and in particular the single-spatial-mode diode laser, which has very high brightness, is that for a given pump mode radius the divergence of the pump beam is smaller. This allows for mode matching of the pump beam to the laser mode over the entire length of the gain element even for very small laser and pump spot sizes and thus results in a maximized saturation parameter Sₗₐₛₑᵣ of the laser (Sₗₐₛₑᵣ=Fₗₐₛₑᵣ/F_{sat,laser}). The number of elements of the pump optics can reduced by using special astigmatic lenses. Likewise a fiber coupled pump element with a comparable brightness can be used.

This pump source (using varying focal length of the achromatic lens 14) is used for four different laser set-ups which all have in common that they have a small laser mode size in the gain medium as well as on the SESAM. These small mode areas are crucial to suppress the laser from operating in the QML regime. The gain element in all these four cavities is a 1 mm thick Kigre QX/Er phosphate glass doped with 0.8% Erbium and 20% Ytterbium (i.e., the glass melt was doped with 0.8% Er₂O₃ and with 20% Yb₂O₃). The thickness of the gain medium is chosen to be not significantly more than the absorption length, to minimize the re-absorption losses. The described laser cavities contain a Brewster/Brewster-cut gain element. Analogous cavities can be done with flat/Brewster or flat/flat gain elements, compensating for the change in astigmatism.

In the following, different kinds of cavity designs are described. In the description and the figures, corresponding reference numerals always refer to corresponding items.

A straight cavity is shown in FIG. 1: The laser resonator is formed by just two mirrors, one of which is the SESAM device 4 and the other one is a concave curved mirror 22. The curved mirror 22 serves as output coupler and has a transmission in the range of 0.2-2% typically at the laser wavelength (around 1550 nm) and is highly transmissive at the pump wavelength (around 980 nm). The Er:Yb:glass gain element 2 is inserted under Brewster angle close to the focus of the pump light 31, located close to the active SESAM surface. The gain element has dimensions of 9×9 mm² in cross-section with a nominal length of approximately 1 mm. (note that the gain element can also be a flat/Brewster shaped element or a flat/flat shaped element with an additional polarization selective element in the cavity). The cavity length is set according to the required laser repetition rate (e.g. about 15 mm for 10 GHz operation). The curvature of the curved mirror 22 is chosen to be slightly larger than the optical length of the cavity to enforce the laser to oscillate close to the stability limit, where the mode size on the SESAM becomes small (Thermal lenses in the gain element can shift the stability regions slightly). This design procedure is using the well-known ABCD matrix technique described, e.g., in A. E. Siegman, Lasers, Mill Valley (Calif.), University Science, 1986. The mode size of the pump light 31 in the gain element has to be about equal to the mode size of the laser light 32 at this position. This sets the focal length of the focusing lens 14. The laser output is collinear to the pump light 31 and reflected on the dichroic mirror 21. This straight cavity is very simple, easy to align, and uses the minimum number of parts required for a non-monolithic mode-locked laser resonator.

In one specific embodiment, we choose the concave curved mirror 22 to have a radius of curvature of 15 mm, a reflectivity of 99.8% at 1550 nm (allowing the laser beam to partially couple out of the cavity here). The distance between the Er:Yb:glass 2 to the mirror 22 is approximately 12.2 mm, the distance from the Er:Yb:glass 2 to the SESAM 4 is 1 mm. This gives a nominal total cavity length of approximately 15.0 mm (taken into account the effective length of the laser gain element 2, i.e., its index of refraction of n=1.521 times its physical length along the optical path of 1.2 mm) which corresponds to a nominal free spectral range (i.e., laser repetition rate) of 10 GHz. In this configuration, the mode radius in the gain medium is 73 μm in the tangential plane and 46 μm in the sagittal plane. The mode radii on the SESAM are 47 μm and 43 μm, respectively.

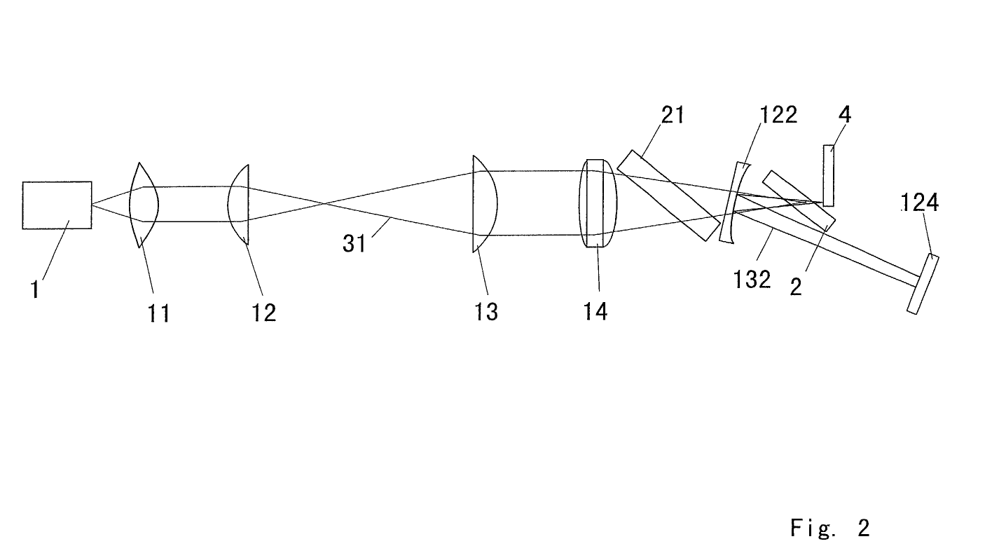

Next, referring to FIG. 2, a first kind of a dog leg cavity is described: The laser resonator is formed by three mirrors, one of which is the SESAM device 4, another one is a concave curved mirror 122 (high reflectivity around 1550 nm; high transmission around 980 nm) and the third one is a flat wedged output coupler with a transmission of 0.2-2% at the laser wavelength (around 1550 nm). The Er:Yb:glass gain element 2 is inserted under Brewster angle close to the focus of the pump light 31, located close to the active SESAM surface. The gain element has dimensions of 9×9 mm² in cross-section with a nominal length of 1 mm (note that the gain element can also be a flat/Brewster element or a flat/flat shaped element with an additional polarization selective element in the cavity). The cavity length is set according to the required laser repetition rate (e.g. about 15 mm for 10 GHz operation). The curvature of the curved mirror 122 can now be much smaller than the cavity length (e.g. radius of curvature 5 mm) compared to the straight cavity of FIG. 1. This allows for even smaller mode sizes of the laser light in the gain medium and on the SESAM. The mode size of the pump light 31 in the gain element has to be about equal to the mode size of the laser light 132 at this position. This sets the focal length of the focusing lens 14. The laser output is now decoupled from the pump light. The dichroic mirror 21 is then used to avoid any feedback of laser light leaking through the high reflector 122 into the pump laser or the pulse generating laser itself. This cavity design allows for even smaller mode sizes in the gain medium and on the SESAM for a fixed pulse repetition rate than the straight cavity design. This is helpful to overcome Q-switched mode locking and helps to saturate the SESAM more strongly. Additionally it reduces the working distance, i.e. the distance between pump focusing lens 14 and gain element 2, which reduces the requirements on the brightness of the pump laser and allows to use smaller aperture optics for the elements 21 and 22. On the other hand it is more complex than the straight cavity shown in FIG. 1 and requires more elements.

In one specific embodiment, we choose the curved high reflecting mirror 122 to have a radius of curvature of 20 mm, and the flat mirror 124 to have a reflectivity of 99.8% at the laser wavelength. The distance between the Er:Yb:glass 2 and the curved mirror 122 is approximately 8.7 mm, the distance between the Er:Yb:glass 2 and the SESAM 4 is approximately 1 mm, and the distance from the curved mirror 122 to the output coupler 124 is 48.8 mm. This gives a nominal total cavity length of approximately 60 mm (taken into account the effective length of the laser gain element 2, i.e., its index of refraction of n=1.521 times its physical length along the optical path of 1.2 mm) which corresponds to a nominal free spectral range (i.e., laser repetition rate) of 2.5 GHz. In this configuration, the mode radius in the gain medium is 53 μm in the tangential plane and 39 μm in the sagittal plane. The mode radii on the SESAM are 20 μm and 20 μm, respectively.

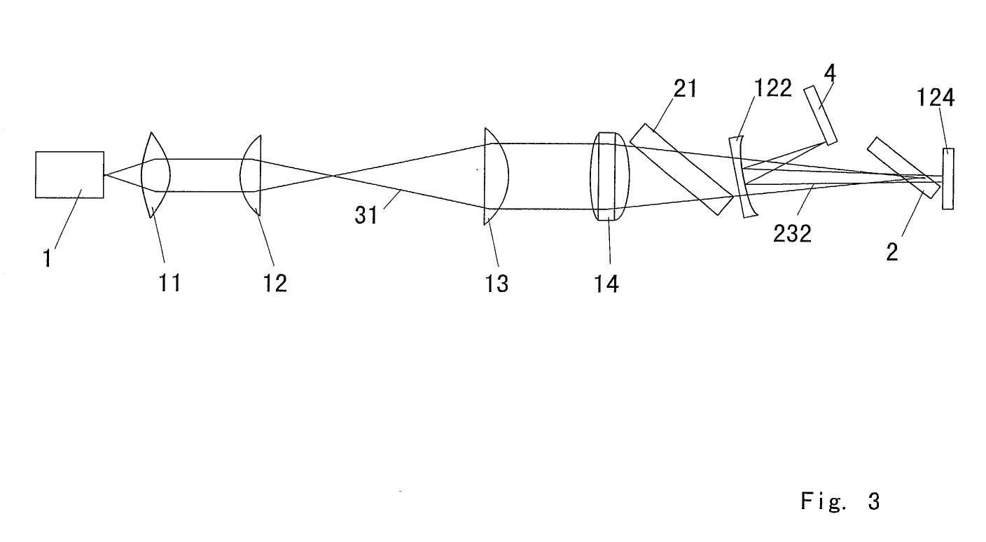

A second dog leg cavity is shown in FIG. 3. This laser resonator is formed by three similar mirrors as the resonator of FIG. 2. One is the SESAM device 4, another one is a concave curved mirror 122 (high reflectivity around 1550 nm; high transmission around 980 nm) and the third one is a flat wedged output coupler with a transmission of 0.2-2% at the laser wavelength (around 1550 nm). The Er:Yb:glass gain element 2 is inserted under Brewster angle close to the focus of the pump light 31, located close to the flat output coupler. The gain element has dimensions of 9×9 mm² in cross-section with a nominal length of 1 mm (note that the: gain element can also be a flat/Brewster element or a flat/flat shaped element with an additional polarization selective element in the cavity). The cavity length is set according to the required laser repetition rate (e.g. about 15 mm for 10 GHz operation). The curvature of the curved mirror 122 can be much smaller than the cavity length (e.g. radius of curvature 5 mm). This allows for very small mode sizes of the laser light on the SESAM. The mode size of the pump light 31 in the gain element has to be approximately equal to the mode size of the laser light 232 at this position. This sets the focal length of the focusing lens 14. Again, the dichroic mirror 21 is then used to avoid any feedback of laser light leaking through the high reflector 122 into the pump laser or the pulse generating laser itself. This cavity design allows for independent mode size adjustment in the gain and on the SESAM. Additionally it relaxes the mechanical constraints due to larger physical distances between the different cavity elements. On the other hand it has larger mode sizes in the gain medium for a fixed pulse repetition rate and slightly increases the working distance, compared to the cavity described referring to FIG. 2.

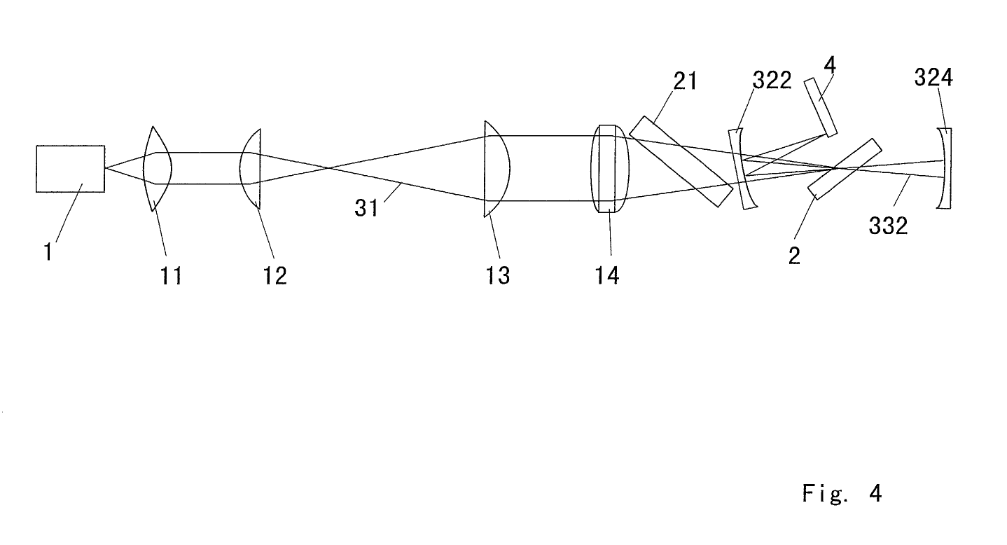

A third example of a dog leg cavity can be seen in FIG. 4. Also this laser resonator is formed by three mirrors. Again, one is the SESAM device 4, but now we work with two concave curved mirrors 322, 324. The first curved mirror 322 has high reflectivity around 1550 nm and high transmission around 980 nm. The second curved mirror 324 is a concave curved output coupler with a transmission of 0.2-2% at the laser wavelength (around 1550 nm). The Er:Yb:glass gain element 2 is inserted under Brewster angle close to the beam waste of the laser beam 332 between mirror the first and the second curved mirror 322, 324. The gain element has dimensions of 9×9 mm² in cross-section with a nominal length of 1 mm (note that the gain element can also be a flat/Brewster element or a flat/flat shaped element with an additional polarization selective element in the cavity). The cavity length is set according to the required laser repetition rate (e.g. about 15 mm for 10 GHz operation). The curvature of the first curved mirror 322 can be much smaller than the cavity length (e.g. radius of curvature 4.1 mm). The curvature of the second curved mirror 324 is chosen so as to get the desired mode size in the gain medium and the desired cavity length. A reasonable value for 10 GHz operation is a radius of curvature of 5 mm. This cavity allows for very small mode sizes of the laser light in the gain medium and on the SESAM, which in addition can be custom designed independently. The mode size of the pump light 31 in the gain element has to be about equal to the mode size of the laser light 332 at this position. This sets the focal length of the focusing lens 14. Again, the dichroic mirror 21 is then use to avoid any feedback of laser light leaking through the high reflector 322 into the pump laser or the pulse generating laser itself. This cavity combines the advantages of the cavities shown in FIGS. 2 and 3: It allows for individual adjustment of the mode sizes in the gain medium and in the SESAM, still having small mode sizes in the gain. In addition to these advantages, this cavity design shows the smallest effect of spatial hole burning, as the gain element is located far away from the cavity end mirrors compared to the thickness of the gain element. This is beneficial to get transform-limited pulses. In terms of working distance it is a compromise of the cavities of FIGS. 2 and 3. However, the working distance is not a limiting factor when a single mode pump is used as was done in this embodiment.

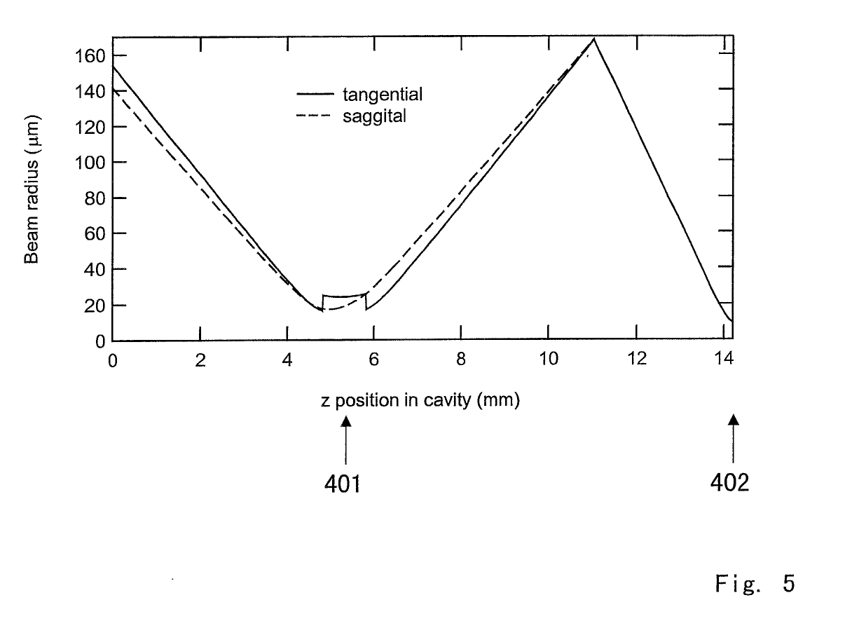

In one specific embodiment, we choose the first curved mirror 322, i.e. the high reflecting mirror, to have a radius of curvature of 4.1 mm, and the second curved mirror 324 to have a radius of curvature of 5 mm with a reflectivity of 99.5% at the laser wavelength. The distance between the Er:Yb:glass 2 and the first curved mirror 322 is approximately 5.2 mm, the distance between the Er:Yb:glass 2 and the curved output coupler is approximately 4.8 mm, and the distance from the first curved mirror 322 to the SESAM 4 is approximately 3.2 mm. This gives a nominal total cavity length of approximately 15.0 mm (taken into account the effective length of the laser gain element 2, i.e., its index of refraction of n=1.521 times its physical length along the optical path of 1.2 mm), which corresponds to a nominal free spectral range (i.e., laser repetition rate) of 10 GHz. In this configuration, the mode radius in the gain medium is 24 μm in the tangential plane and 18 μm in the sagittal plane. On the SESAM, they are 10 μm and 10 μm, respectively. The mode size, as function of the position in the cavity is shown in FIG. 5. The two beam waists for the SESAM 402 and the Er:Yb:glass 401 can be seen clearly. In the Figure, z denotes the distance from the second curved mirror 324.

In these configurations we typically achieved average output powers between 5 to 50 mW.

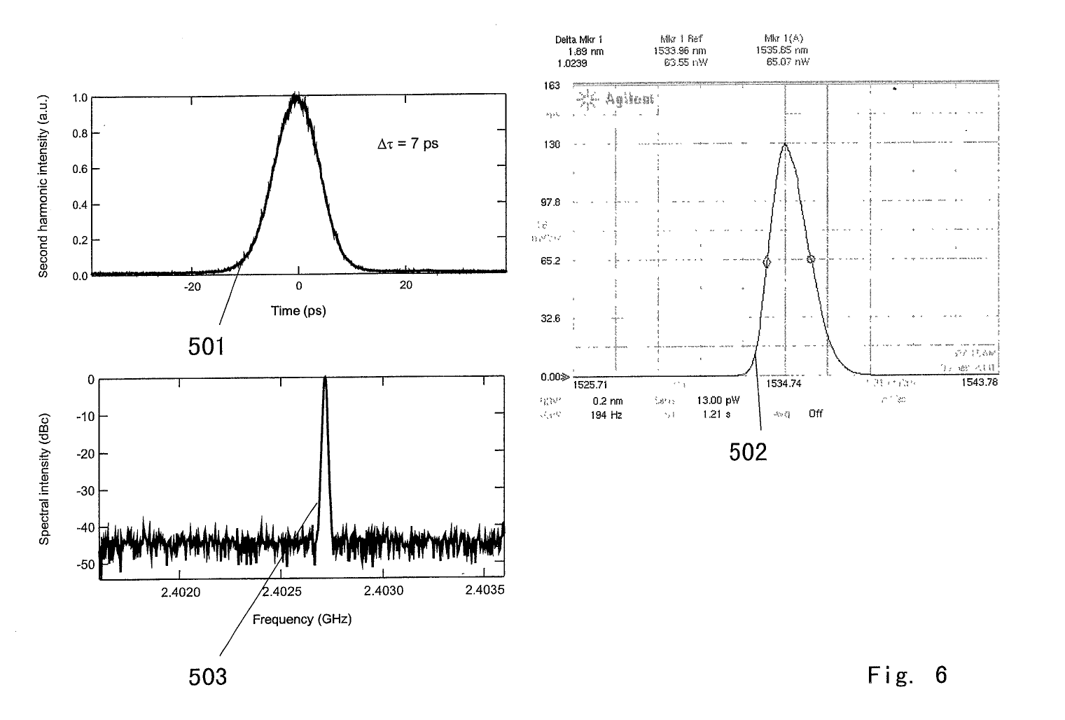

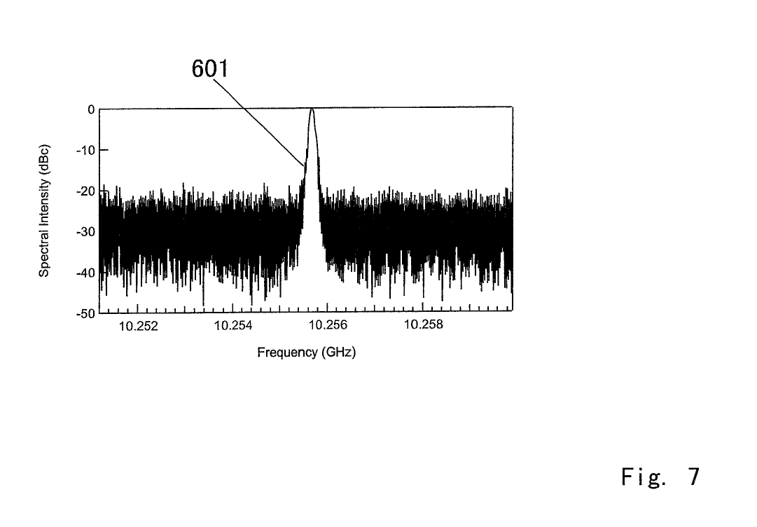

The basic design described above with reference to FIGS. 1-4 can be operated at frequencies exceeding 1 GHz. FIG. 6 shows data taken from a laser operating near 2.5 GHz: the autocorrelation trace 501, the optical spectrum of the laser 502 and the RF-spectrum 503 indicating clean mode-locked operation. This data is taken form a laser designed according to FIG. 2. In FIG. 7 the RF spectrum from a 10 GHz laser is shown, designed according to FIG. 4.

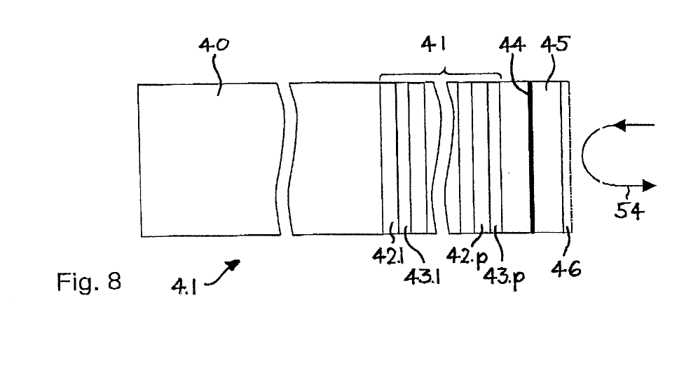

FIG. 8 illustrates a preferred design of a SESAM 4.1. A dielectric stack mirror 41 (typically called a Bragg reflector) consisting of quarter-wave pairs of low-index/high-index material 42.1, . . . , 42.p and 43.1, . . . , 43.p, respectively. These mirrors 41 are well known to those skilled in the art of mirrors. The specific design starts with a gallium arsenide (GaAs) substrate 40 of with a thickness range of typically 400 to 650 microns. First a quarter wave layer 42.1 of a low-index material, in this case aluminum arsenide (AlAs) with an index of refraction of n=2.89 and a thickness of approximately 134 nm (corresponding to a quarter wavelength of 1550 nm in the AlAs), is deposited onto the substrate 40. The deposition method is typically the well-established techniques of molecular beam epitaxy (MBE) or metal-organic chemical vapor deposition (MOCVD). A high-index layer 43.1 consisting of gallium arsenide (GaAs) with a refractive index of n=3.38 and a quarter-wave thickness of 115 nm is then deposited. Typically this is repeated approximately p=25 to 30 times (i.e., 25 to 30 times a low-index/high-index pair). Such a Bragg mirror 41 gives a reflectivity of typically higher than 99.5% and preferably higher than 99.9% at the center of its design wavelength. A reflection of incoming light is schematically depicted by an arrow 54.

Then an absorber layer 44 is deposited inside or at the edge of a transparent half-wave spacer layer 45 on top of the Bragg mirror 41. The transparent half-wave spacer layer 45 does not substantially modify the reflectivity or wavelength range of the Bragg mirror 41. This design is referred to as a “low-finesse” design, since there is no Fabry-Perot mirror element above the spacer layer 45, and no enhancement of the field inside the absorber layer with respect to the incident field strength. In one specific embodiment, the absorber layer 44 is indium gallium arsenide (InₓGa₁₋ₓAs), where the ratio x of the indium is 53% and the ratio of the gallium is 1−x=47%. This sets the absorption bandgap of the semiconductor absorber layer 44 to substantially 1550 nm. The thickness of the absorber layer 44 sets the total amount of change in absorption (i.e., the modulation depth ΔR) of the SESAM device 4.1. In our described example, the InGaAs absorber layer 44 is approximately 5 nm thick, and the half-wave spacer layer 45 consisting of GaAs has a total thickness of 229 nm including the 5 nm thickness of the absorber layer 44. With an absorber thickness of 5 nm, we obtain a modulation depth of approximately 0.1% to 0.2% (the difference depending on the exact growth and fabrication of the SESAM device). Note that the different index of refraction of the absorber layer 44 compared to the spacer layer 45 and its thickness have to be taken into account for designing the completed half-wave layer thickness, although for most designs this slight difference is negligible.

The absorber layer 44 can be positioned at an arbitrary point in the electric field of the optical beam within the Bragg reflector 41, by selecting the position of the absorber layer 44 within the half-wave layer 45. Typically the electric field in the half-wave layer 45 starts at substantially zero at one end, increases to a maximum in the middle, then decreases down to substantially zero at the exit surface. By positioning the absorber layer 44 substantially in the middle of the half-wave layer 45, we achieve maximum saturation of the absorber 44 for a given incident optical intensity, and we also achieve a minimum effective saturation fluence for the SESAM 4.1. However it can be desirable to reduce the modulation depth of the device 4.1 by positioning the absorber layer 44 closer to either end of the half-wave spacer layer 45. If the absorber layer 44 is positioned effectively at a very end of the half-wave spacer layer 45, the electric field strength approaches zero, and the modulation depth and effective saturation of the absorber 44 also approach zero. However, these two effects counterbalance any change of the QML threshold.

One important materials issue with InGaAs absorbers is the “strain” introduced by the high concentration of indium. This is due to a change in the lattice constant, i.e. the atomic spacing, in the crystalline structure, as the indium concentration is increased. This strain between the underlying GaAs layer and the InGaAs absorber layer due to the lattice mismatch results in build-up of stress which causes crystalline defects to form to relieve such stress. The effect is termed “relaxation” of the lattice, i.e. the lattice constant then returns to its “natural” value for the InGaAs. In the absorbers disclosed here with approximately 53% In concentration, the critical thickness, i.e. where the material begins to fully relax, is on the order of 2 nm. This means that for representative absorber layer thickness, we expect to have fully-relaxed absorber layers. Normally this results in a substantial decrease in the crystalline and optical qualities of the absorber layer and all crystalline material layers subsequently grown on top of this layer. This can result in strong surface cross-hatching or hazing, corresponding to poor optical quality and reflectivity, which may result in unsatisfactory laser performance, to the level that passive modelocking can even be suppressed or the laser cannot operate above the power level necessary to reach the QML threshold.

We have observed, however, that we can avoid these problems by growing thin layers, in the range of 20 nm or less, in last “spacer” layer of the structure, such that the absorber is about 110 nm or less from the surface. The remaining top layer of approximately 100 nm can be grown with a minimum of crystalline and optical quality degradation. This process is also apparently helped by growing the absorber layer at reduced growth temperature, typically below 440 C. (where In adsorbs from the already-grown material) to as low as 250 C. (preferred is circa 380 C.). Even if there are defects in the absorber layer due to lattice mismatches, the small thickness of the absorber layer plus the thickness of the top layer (in the range of approximately 100 nm to 125 nm for a GaAs top layer, potentially as thick as 200 nm in the case of using an AlAs top layer) usually results in a final device with low non-saturating losses and a good optical quality surface.

It is worth noting that the absorber layer thickness is approaching (theoretically) a value where quantum-well effects can play a role (i.e. where confinement of the absorber layer produces a shift in the bandgap energy). Normally a quantum well would have an enhanced exciton peak, resulting in a lower saturation fluence for the absorber. However for absorber layers with high levels of Indium (53% typically for absorption of 1.55 nm light), the material is typically highly relaxed (i.e. disordered). This means that although it is a very thin layer, and there may be confinement effects typical of quantum wells, these effects are smeared out so that they are effectively negligible. Fortunately quantum well and exciton effects are not essential for proper SESAM operation, and the absorber layer thickness is a parameter chosen to achieve a desired modulation depth ΔR. Note that in any case the temperature of the absorber can be changed to cause a shift in the absorption versus wavelength profile.

It may be desirable to passivate and protect the surface of the semiconductor spacer layer 45, i.e., to prevent contaminants and oxidants from possibly degrading the optical qualities of the semiconductor material. In this case, it is possible to put a very thin layer 46 of a material such as silicon (Si) directly on the top of the last semiconductor layer 45. If this passivation (or protection) layer 46 is very thin, it does not substantially change the optical properties of the SESAM device 4.1. However it will sufficiently protect and passivate the top surface. For example, several nanometers (typically 2 to 20 nm, preferably 2 to 4 nm) of silicon can be directly deposited on the top surface of the SESAM 4.1 after it has been fabricated in an MBE or MOCVD system. This coating step can be done in the same system before the SESAM device 4.1 has been removed from the coating chamber (which is under high vacuum) and before it has been exposed to possible contaminants and oxidants (oxygen and water vapor in room air, for example). The passivation layer 46 lets us operate the SESAM device 4.1 at higher optical intensities before damage occurs, which in turn facilitates achieving higher repetition rate modelocking as described by Eq. (1), by improving the fluence ratio on the SESAM device 4.1.

Another observation that we have made is that small reflections from the rear surface of the SESAM can cause etalon effects which can cause very small but undesired modulation to the reflectivity response of the SESAM. This etalon effect from the SESAM can be reduced or removed by processing the SESAM to have a wedged rear surface. Due to the high index of refraction of the GaAs substrate material, a wedge of substantially greater than 1 degree, preferable 3-5 degrees, can be used.

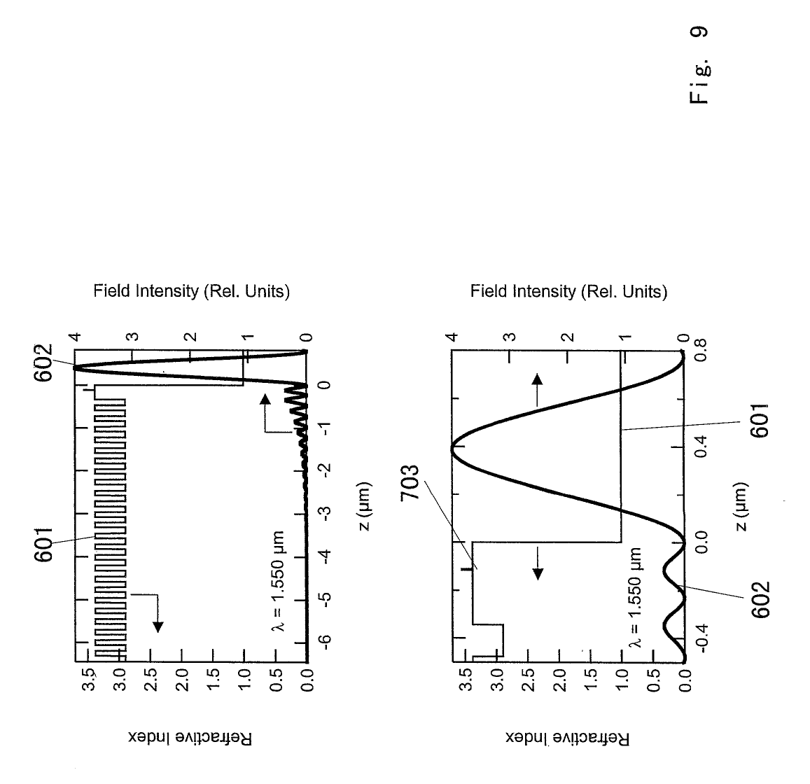

FIG. 9 shows the refractive index 601 and the calculated electrical field intensity 602 in a SESAM device as a function of the distance from the SESAM surface. The setup is chosen so that electrical field intensity inside the transparent half wave spacer layer is at a local maximum at the position 703 of the absorber layer 44, as can be seen in the lower panel of the Figure.

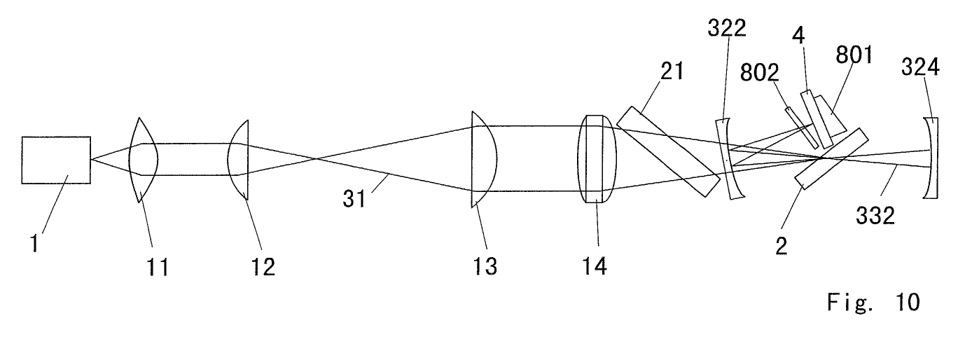

It is also possible to introduce wavelength selective elements such as a prism, rotatable grating, filters, etalons, interferometers etc. into the laser cavity to control the center wavelength of the laser emission. Further, also tuning means for repetition rate tuning may be present. FIG. 10 shows, as an example, the laser of FIG. 4 together with such means. The repetition rate tuning means 801, i.e. the cavity length stabilizing and tuning means is e.g. a piezo element, on which a mirror element—in the shown embodiment the saturable absorber 4—is mounted. Instead of a piezo element, the repetition rate tuning means could also be a movable glass wedge or a prism arranged transversely in the cavity or anything else which influences the optical roundtrip path in the cavity. The wavelength tuning element 802 is preferably an etalon with solid or free space or a birefringent filter or a combination of these two elements. It could also be an intracavity dispersive element such as a prism or the like.

According to an embodiment of the invention, a micro-optics arrangement is chosen, which allows the combination of this laser with means to tune and lock the laser wavelength, at the same time to tune and lock the cavity length of the laser to synchronize the pulse repetition rate to a master reference clock.

Repetition rate locking is achieved by providing a means to move one of the cavity elements. A preferred embodiment is to put the SESAM (which is small and has low mass, thereby allowing for maximum operating frequency of the moving element) onto a piezoelectric element which can move the SESAM in the direction of the optical axis by approximately one micron. This allows us to adjust the cavity repetition rate by approximately 0.67 MHz per micron of cavity length change at 10 GHz repetition rate, or by 10.7 MHz per micron at 40 GHz repetition rate.

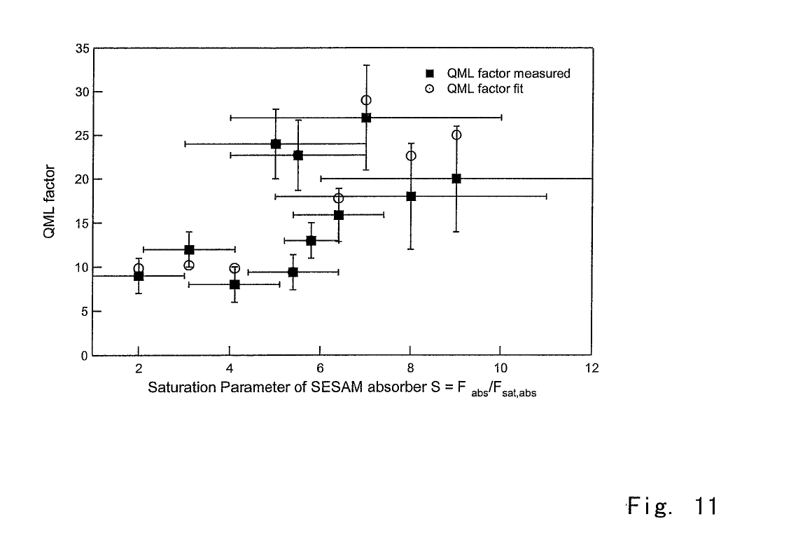

As mentioned previously, we have observed that the surprising fact that the pulse energy for QML threshold is significantly lower than standard expected QML threshold. We have investigated this effect. FIG. 11 shows a plot of the measured QML factor as a function of the saturation parameter of the SESAM for a number of different cavity configurations (each data point corresponds to a separate laser). The data points come from a set of experiments where we mapped out the parameter space changing the saturation parameter of the SESAM, the saturation parameter of the gain, and the repetition rate of an Er:Yb:glass laser with a single SESAM.

From this data we have calculated an empirical fit which correlates the observed QML factor q to the mode size in the laser material. The figure shows first of all that we measure QML parameters between 5 and 30. The calculated data, referred to as QML factor fit, originates from the following procedure. In the data points with a saturation parameter of the SESAM around 5.5 (that do not show any obvious fit or correlation) we see a clear trend of the QML factor versus gain saturation factor (S_{gain}=F_{gain}/F_{sat,gain}), which can then be fitted. Taking this analytical dependence of the QML factor on the gain saturation as given, we can then calculate the QML factor for the other lasers with different saturation parameters of the SESAM and different repetition rates and we get a good agreement with the measured data.

This empirically observed improvement in the QML threshold of these lasers is one important factor allowing us to achieve high repetition rates as disclosed here.

The above described embodiments are merely examples of ways to carry out the invention and are by no means limiting. Combinations of the features of these embodiments as well as numerous other embodiments may be envisaged without departing from the spirit and scope of the invention. Further, the invention is not limited by the above outlined physical interpretations of the observed phenomena, should they turn out to be not entirely apt.

What is claimed is:

1. A laser for emitting a continuous-wave train of electromagnetic-radiation pulses characterized by an effective wavelength, the fundamental repetition rate of the emitted pulses exceeding 1 GHz, said laser comprising:
an optical resonator;
an Er:Yb:doped solid-state gain element placed inside said optical resonator;
optical pumping means for exciting said laser gain element to emit electromagnetic radiation characterized by the effective wavelength; and
means for passive modelocking comprising a saturable absorber.

2. The laser of claim 1 wherein said gain element is an Er:Yb:glass gain element.

3. The laser of claim 1 wherein said saturable absorber is a semiconductor saturable absorber mirror device.

4. The laser of claim 3 wherein said saturable absorber has a modulation depth below 0.5% and non-saturating loss of below 0.5%.

5. The laser of claim 3, said semiconductor saturable absorber mirror device comprises a GaAs/AlAs mirror, at least one GaAs spacer and an InGaAs absorber layer.

6. The laser of claim 5, wherein said saturable absorber mirror comprises GaAs/AlAs mirrors and an absorber layer comprising less than or equal to 10 nm thick of relaxed In(x)Ga(1−x)As, where x is substantially greater than or equal to 50%.

7. The laser of claim 6, wherein the absorber layer has a thickness less than or equal to 5 nm, wherein the absorber layer is arranged at or near the surface of the SESAM structure, surface, i.e. within substantially 200 nm from the SESAM surface, and wherein the absorber layer has been grown at temperatures below 500° C.

8. The laser of claim 3, wherein the semiconductor saturable absorber mirror has a modulation depth of less than 0.5%.

9. The laser of claim 3 wherein the cavity is designed in a manner that the mode radius in the gain element is below 80 μm and the mode radius on the semiconductor saturable absorber is below 50 μm.

10. The laser of claim 3, wherein the cavity is designed in a manner that the mode radius in the gain element is below 30 μm and the mode radius on the semiconductor saturable absorber mirror device is below 20 μm

11. The laser of claim 1 comprising focusing means for focusing an optical pumping beam emitted by said optical pumping means, said focusing means and elements of the optical resonator being chosen and arranged in a manner that said saturable absorber and said gain element are placed at or near the focus of the optical pumping beam.

12. The laser of claim 1 comprising focusing means for focusing an optical pumping beam emitted by said optical pumping means, wherein the optical resonator comprises curved mirror elements being arranged in a manner that electromagnetic radiation circulating in the resonator is focused twice, wherein said curved mirror elements and said pumping beam focusing means are chosen and arranged in a manner that a first focus of the circulating beam essentially coincides with the focus of the optical pumping beam, wherein the gain element is placed at or near said first focus, and wherein the saturable absorber is placed at or near the second focus of the circulating beam.

13. The laser of claim 1, wherein the repetition rate substantially equals or exceeds 2 GHz.

14. The laser of claim 13, wherein the repetition rate substantially equals or exceeds 10 GHz.

15. The laser of claim 14, wherein the repetition rate substantially equals or exceeds 40 GHz.

16. The laser of claim 1 comprising wavelength tuning means.

17. The laser of claim 1 comprising means for tuning the fundamental repetition rate.

18. The laser of claim 1 further comprising wavelength locking means.

19. The laser of claim 1 wherein said means for exciting said laser gain element comprise a single spatial mode laser diode.

20. The laser of claim 1 wherein said means for exciting said laser gain element comprise a high brightness single-emitter broad-area laser diode.

21. The laser of claim 1 being designed for operation at an effective wavelength between 1525 nm and 1570 nm and possibly comprising wavelength selective elements in the resonator ensuring operation at an effective wavelength between 1525 nm and 1570 nm.

22. A laser for emitting a continuous-wave train of electromagnetic-radiation pulses characterized by an effective wavelength, the fundamental repetition rate of the emitted pulses exceeding 1 GHz, said laser comprising:
an optical resonator;
an solid state gain element placed inside said optical resonator;
means for exciting said laser gain element to emit electromagnetic radiation characterized by the effective wavelength, said means comprising a single mode diode pump laser with an output power of 0.2 W or more; and
means for passive modelocking comprising a saturable absorber.

23. A laser for emitting a continuous-wave train of electromagnetic-radiation pulses characterized by an effective wavelength, the fundamental repetition rate of the emitted pulses exceeding 1 GHz, said laser comprising:
an optical resonator;
an solid state gain element placed inside said optical resonator;
means for exciting said laser gain element to emit electromagnetic radiation characterized by the effective wavelength, and
means for passive modelocking comprising a low-finesse Semiconductor Saturable Absorber Mirror (SESAM) with GaAs/AlAs mirrors and a less than or equal to 10 nm thick absorber layer comprising InₓGa₁₋ₓAs with 0.5<x<0.56.

24. The laser of claim 23, wherein the absorber layer has a thickness less than or equal to 5 nm, wherein the absorber layer is arranged at or near the surface, i.e. within substantially 200 nm from the SESAM surface, of the SESAM structure, and wherein the absorber layer has been grown at temperatures below 500° C.

25. A laser for emitting a continuous-wave train of electromagnetic-radiation pulses characterized by an effective wavelength, the fundamental repetition rate of the emitted pulses exceeding 1 GHz, said laser comprising:
an optical resonator;
an Er:Yb:doped solid-state gain element placed inside said optical resonator;
means for exciting said laser gain element to emit electromagnetic radiation characterized by the effective wavelength; and
means for passive modelocking comprising a saturable absorber,
wherein the optical resonator is designed such that the circulating radiation is focused in a manner that the spatial mode radius in the gain element is below 80 μm and on the semiconductor saturable absorber below 50 μm.

26. The laser of claim 25, wherein the repetition rate substantially equals or exceeds 10 GHz.

27. A method for emitting a continuous-wave train of electromagnetic-radiation pulses characterized by an effective wavelength, the pulses being emitted with a fundamental repetition rate exceeding 1 GHz, comprising the steps of:
exciting an Er:Yb:doped solid-state laser gain element to emit electromagnetic radiation characterized by the effective wavelength,
said laser gain element being placed inside an optical resonator;
recirculating said electromagnetic radiation in said optical resonator; and
passively modelocking said electromagnetic radiation using a saturable absorber.

28. The method of claim 27 wherein said saturable absorber is chosen to be a semiconductor saturable absorber mirror device.

29. The method of claim 27, wherein the pulses are emitted with a repetition rate substantially equaling or exceeding 10 GHz.

30. The method of claim 29, wherein the pulses are emitted with a repetition rate substantially equaling or exceeding 40 GHz.

31. A method for emitting a continuous-wave train of electromagnetic-radiation pulses characterized by an effective wavelength, the pulses being emitted with a fundamental repetition rate exceeding 1 GHz, comprising the steps of:
Focusing an optical pumping beam on a solid state laser gain element for exciting it to emit electromagnetic radiation characterized by the effective wavelength,
said laser gain element being placed inside an optical resonator;
recirculating said electromagnetic radiation in said optical resonator,
passively modelocking said electromagnetic radiation using a saturable absorber, and
focusing said electromagnetic radiation such that the spatial mode radius in the gain element is below 80 μm and on the semiconductor saturable absorber below 50 μm.
